(19) United States
(12) Patent Application Publication
(10) Pub. No.: US 2005/0279286 A1
(43) Pub. Date: Dec. 22, 2005

(54) Climatically-controlled pet bed

(76) Inventor: Christopher A. Youngmark, Chicago, IL (US)

Correspondence Address: MERONI + MERONI, P.O. BOX 309, BARRINGTON, IL, 60011, US

(21) Appl. No.: 11/154,029

(22) Filed: Jun. 16, 2005

Related U.S. Application Data
(60) Provisional application No. 60/580,629, filed on Jun. 17, 2004.

(51) Int. Cl. A01K 29/00

(52) U.S. Cl. 119/28.5

(57) ABSTRACT

The present invention discloses a bed assembly for enhancing a pet's bedded comfort level. The bed assembly comprises a support member, an air conduit, and an air current source. The support member is designed to support a pet and has a superior pet support surface, an inferior air-receiving surface, and a plurality of air-conducting apertures. The apertures extend from the superior pet support surface to the inferior air-receiving surface for conducting air current(s) from the inferior air-receiving surface to the superior pet-support surface. The air current source provides air current(s), which pass from the air current source to the superior pet support surface via the air conduit and the air-conducting apertures. The air current, having been selectively air conditioned, climatically-controls the pet support space located in superior adjacency to the superior pet support surface. The climatically-controlled pet support space is thus designed to enhance a pet's bedded comfort level.

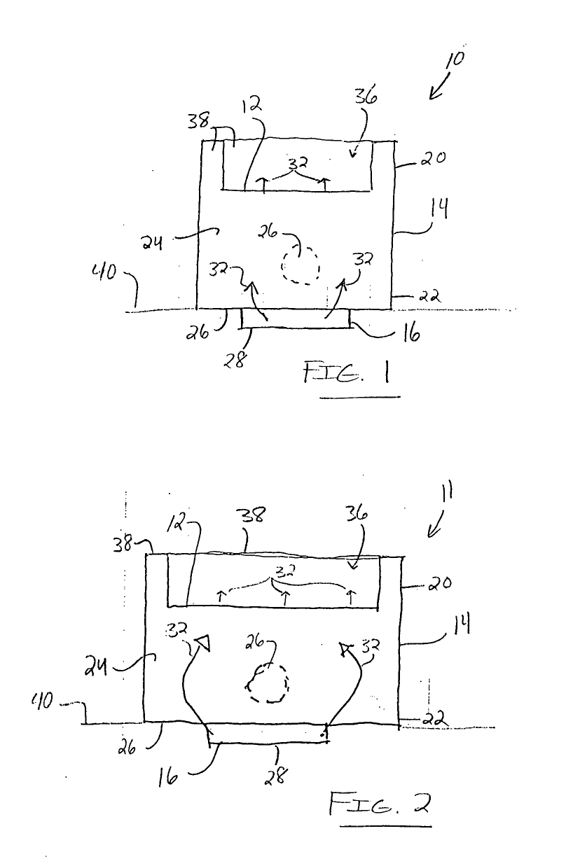

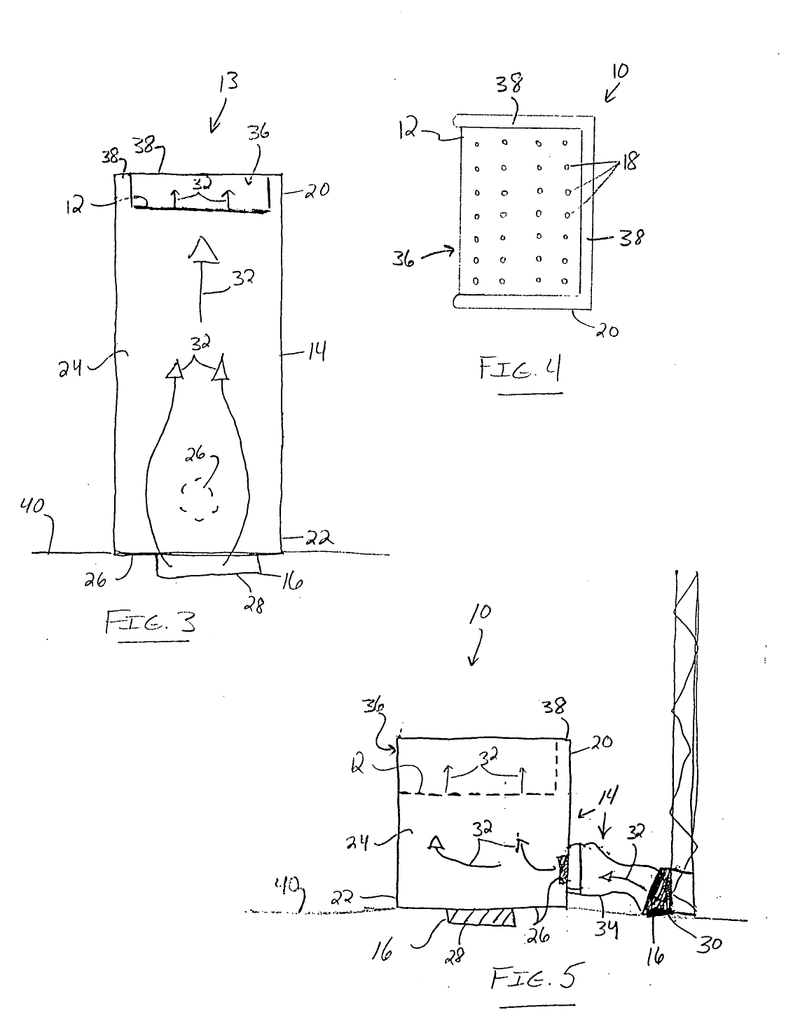

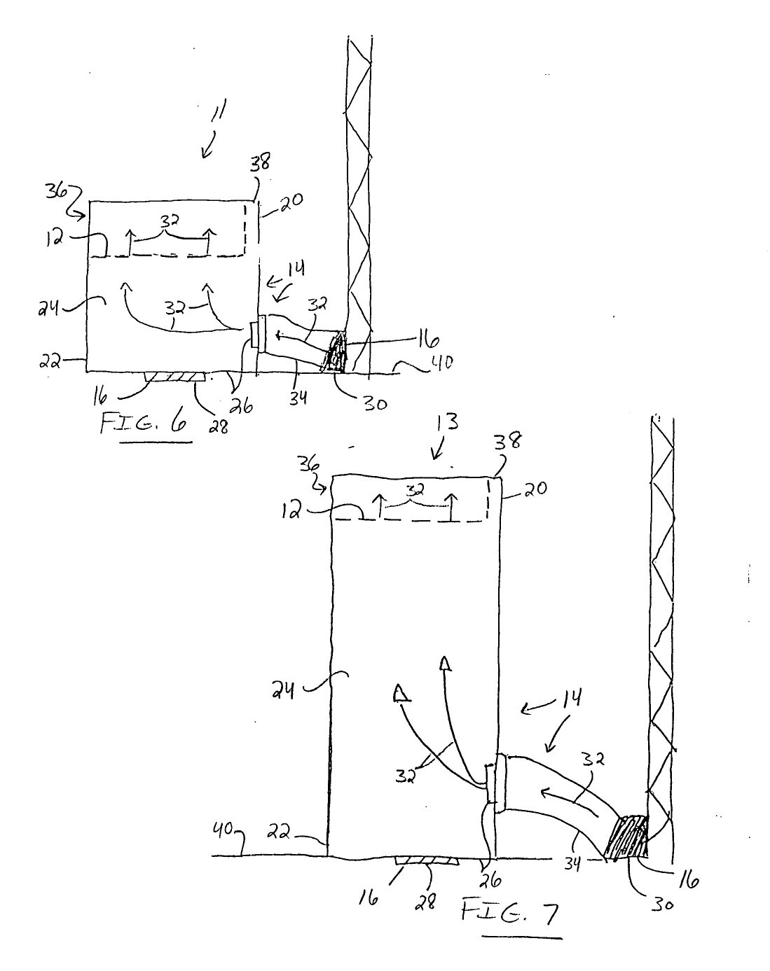

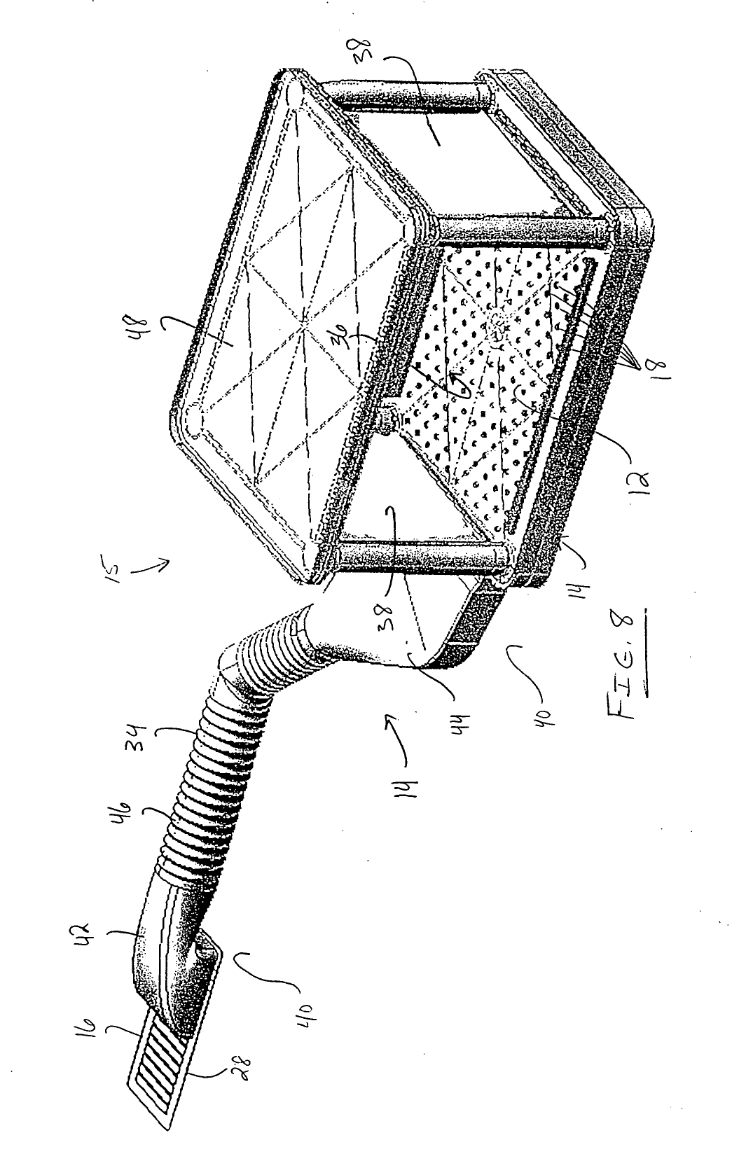

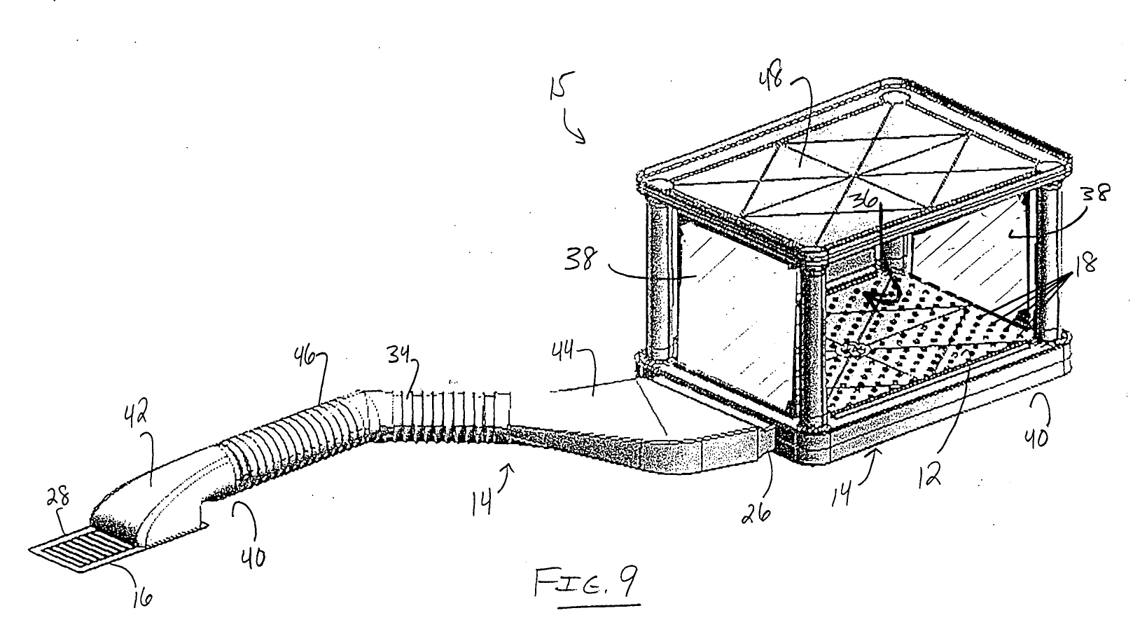

### PRIOR HISTORY

This application is a non-provisional patent application claiming the benefit of pending provisional U.S. patent Application Ser. No. 60/580,629, filed in the United States patent and Trademark Office on Jun. 17, 2004.

### BACKGROUND OF THE INVENTION

1. Field of the Invention

The claimed invention generally relates to a bedding apparatus for pets and the like. More specifically, the claimed invention relates to an improved, climatically-controlled bedding apparatus for providing an ambient temperature to pets situated upon the apparatus so as to enhance the environmental surroundings and thus the comfort level of the targeted pet.

2. Background

Pet enthusiasts continue to drive development of various types of pet products in the market place. Among the various types of pet products are bedding devices for pets. Pets, such as cats and dogs, are often sedentary for a large portion of any given time frame and may often be found napping or resting. Pet beds provide pet owners with a site specific location for directing pets during periods of sedentary repose. Pet owners are often desirous of improving or enhancing the comfort level for their pets and thus comfort-enhancing pet beds continue to be developed. The prior art thus teaches a number of disclosures designed for enhancing the comfort level for pets. Some of the prior art patents dealing with this type of subject matter are briefly described hereinafter.

U.S. Pat. No. 5,134,972 ('972 patent), which issued to Compagnucci, discloses a Ventilated Pet Litter Box. The '972 patent teaches a ventilated pet litter box for use in a closed space comprising a litter receptacle, a receptacle cover, a vibration-damped exhaust fan communicating with the receptacle cover and a wall orifice attachment, and a wall orifice attachment to discharge ventilating forced air to outside of the closed space. It will thus be seen from an inspection of the '972 patent that the device provides a pet litter box that can be placed at any location within a closed space having means to exhaust litter odors to the outside of the closed space so as to increase the comfort level of the target pet. It will be further seen that the device as taught by the '972 patent teaches a litter box ventilation system incorporating noise and vibration-damping means to prevent the pet from experiencing traumatic noise and vibrations.

U.S. Pat. No. 5,140,948 ('948 patent), which issued to Roberts, discloses a Vented Cat Litter Box Apparatus. The '948 patent teaches an enclosure defining a litter box. The enclosure comprises a base portion and a removable upper portion mounted to the base portion. A door to the upper portion includes a signal generating switch to effect actuation of a blower motor positioned coaxially within an exhaust conduit directed through the upper portion. It will be seen from an inspection of the '948 patent that the subject device is designed to ventilate otherwise noxious odors from the cat litter area as a means to improve the comfort level of the targeted pet.

U.S. Pat. No. 5,311,837 ('837 patent), which issued to Mamer-Boellstorff, discloses a Pet Bed. The '837 patent teaches a pet bed designed to be comfortable for the pet, easily cleaned, and exceptionally durable. The bed is constructed from a unitary piece of molded plastic with an oval, concave resting area for the pet. The resting surface has numerous holes which allow for ventilation for the animal and also provide for removal of water when the bed is cleaned as by spraying with a water hose. The peripheral support walls of the bed are fitted with several cutouts which increase ventilation, allow for the escape of water from beneath the bed during cleaning, and provide convenient hand-holds when lifting the bed. The bed may also be fitted with a pair of snap hooks for securing it to a kennel fence.

U.S. Pat. No. 5,655,478 ('478 patent), which issued to Kiera, discloses a Ventilation System Adapted for Use with Litter Boxes. The '478 patent teaches an adapter device for providing forced air ventilation to a litter box having an upper vent location. The adapter device comprises a housing member of generally rectangular configuration having a lower portion, an interior portion, and an upper portion. An external duct fitting is mounted upon the upper portion, and a downwardly dependent skirt member extends continuously around the lower portion. An internal duct extends upwardly through the lower portion of the housing member, through the interior portion, being connected to the external duct fitting located on the upper portion. An electric fan is located in the interior portion and operatively mounted in the internal duct, with electric current being supplied to the fan so that it can selectively be caused to rotate and cause air from the litter box to be pumped upwardly through the internal duct to the external duct fitting located on the upper portion. A flexible hose is connected to the external duct fitting for delivering the air to a remote location. This adapter device causes air to be removed form the litter box and to be delivered through the flexible hose to the remote location.

It will be seen from an inspection of these prior art disclosures as well as from a consideration of other types pertinent art commonly known that the prior art teaches a number of enclosures for pets and the like, which may be outfitted with ventilations systems and/or other comfort-enhancing means. It will be further seen, however, that none of the prior art teaches a climatically-controlled pet bed designed to provide an ambient temperature to the targeted or situated pet. Thus, the prior art perceives a need for a pet bed designed to provide an ambient temperature to a pet situated upon a pet bed so as to increase or enhance the comfort level of the pet.

### SUMMARY OF THE INVENTION

Accordingly, in order to address the need in the prior art for a pet bed that provides a pet with a comfort-enhancing, climactically-controlled pet bed, the present invention provides a Climatically Controlled Pet Bed. It is an object of the present invention to provide a pet bed comprising climate control means, the climate control means for providing an ambient temperature to a pet situated upon the pet bed. It is a further object of the present invention to provide means for controlling the ambient humidity levels for a pet situated upon the pet bed. To achieve these and other readily apparent objectives, the present invention provides climactically-controlled pet bed, the pet bed essentially comprising a pet support surface, forced air conduit means, and a source of forced air. The pet support surface is essentially a substantially planar member with a series of air-conducting apertures formed therein. The forced air conduit means essentially serves a dual function, namely, to maintain the pet support surface in a substantially horizontal state and to provide a guideway for forced air from the source of forced air to the air-conducting apertures formed in the pet support surface. The forced air conduit means thus comprises a superior end, an inferior end and at least wall continuous wall joining the superior end to the inferior end. Notably, the inferior end is positionable adjacent the source of forced air and comprises forced air inlet means. The source of forced air or forced air outlet may preferably be defined by a common household floor vent or wall vent. It is noted that the ultimate source of forced air in a household is typically the fan or blower of a furnace or air conditioner. This source feeds forced air into a series of air duct leading to various rooms in a house or similar other building structure. The noted air ducts typically terminate in either floor vents or wall vents depending on the type of construction in a given household. For purposes of the present invention, the floor vents or wall vents as herein described, define the forced air source or forced air outlet of the present invention.

Notably, the forced air exiting the wall vents or floor vents is typically conditioned in some way prior to being forced through the described ductwork. The air may either be heated (such as is the case when the home or business owner desires to maintain a heated environment in the vented room) or the air may be cooled or otherwise air conditioned (such as is the case when the home or business owner desires to maintain a cooled or air conditioned environment in the vented room). It is contemplated that the present use of the term “air conditioned” refers to the air that has been treated by a common air conditioning unit. Thus, “air conditioned” is meant to convey the notion that the forced air emanating from the source of forced air or forced air source has been either reduced in temperature and/or adjusted for comfortable humidity levels (either by humidifying or dehumidifying the air). The forced air, having been treated as described, thus exits the air-conducting apertures and maintains a pre-selected ambient temperature and/or humidity level for the pet atop the pet support surface.

Other objects of the present invention, as well as particular features, elements, and advantages thereof, will be elucidated or become apparent from, the following description and the accompanying drawing figures.

### BRIEF DESCRIPTION OF THE DRAWINGS

Other features of my invention will become more evident from a consideration of the following brief description of my patent drawings, as follows:

FIG. No. 1 is a front plan view of the preferred embodiment of the climatically-controlled pet bed positioned in superior adjacency to a floor vent.

FIG. No. 2 is a front plan view of a first alternative embodiment of the climatically-controlled pet bed positioned in superior adjacency to a floor vent.

FIG. No. 3 is a front plan view of a second alternative embodiment of the climatically-controlled pet bed positioned in superior adjacency to a floor vent.

FIG. No. 4 is a top plan view of the preferred embodiment of the climatically-controlled pet bed showing an apertured pet support surface.

FIG. No. 5 is a side plan view preferred embodiment of the climatically-controlled pet bed positioned in superior adjacency to a floor vent and connected to a wall vent.

FIG. No. 6 is a side plan view of the first alternative embodiment of the climatically-controlled pet bed positioned in superior adjacency to a floor vent and connected to a wall vent.

FIG. No. 7 is a side plan view of the second alternative embodiment of the climatically-controlled pet bed positioned in superior adjacency to a floor vent and connected to a wall vent.

FIG. No. 8 is a first perspective view of a third embodiment of the climatically-controlled pet bed positioned adjacent a floor vent and connected thereto via conduit structure.

FIG. No. 9 is a second perspective view of the third embodiment of the climatically-controlled pet bed positioned adjacent a floor vent and connected thereto via conduit structure.

### DETAILED DESCRIPTION OF THE PREFERRED EMBODIMENT

Referring now to the drawings, the preferred embodiment of the present invention concerns a climatically-controlled pet bed 10 as generally illustrated and referenced in FIG. Nos. 1, 4, and 5. Pet bed 10 preferably comprises a pet support surface or pet support member 12 as illustrated and referenced in FIG. Nos. 1-9 inclusive; forced air conduit means 14 as illustrated and referenced in FIG. Nos. 1-3, and 5-9; and a source of forced air or forced air source 16 as illustrated and referenced in FIG. Nos. 1-3, and 5-9. It will be seen from an inspection of FIG. Nos. 1-3, and 5-9 that pet support member 12 is preferably comprises a substantially planar member upon which pets and the like may position themselves. Preferably pet support member 12 is constructed from a substantially rigid material such as wood or plastic. Notably, pet support member 12 must be capable of supporting a load as represented by a pet positioned atop pet support member 12. In this regard, the materials used, whether wood or plastic, must be of sufficient rigidity (typically achieved through a sufficient thickness) so as to withstand downward acting load forces coinciding with the positioned pet. For example, it is contemplated that given a common household cat, pet support member 12 should be constructed from a sheet of hard wood having about 0.25 inch thickness so as to support the cat. Pet support member 12 further preferably comprises a series of air-conducting apertures 18 formed therein as illustrated and referenced in FIG. Nos. 4, 8, and 9. The apertures may be formed by boring holes through the thickness of pet support member 12, the bore axes being generally orthogonal to the plane of pet support member 12.

It will be seen from an inspection of FIG. Nos. 4, 8, and 9 that there are numerous air-conducting apertures 18 formed in pet support member 12. It is contemplated that the spacing between air-conducting apertures 18 be on the order of 1 to 2 inches depending on the size of the targeted pet. In other words, it is contemplated that the spacing would be on the order of 1 inch (side by side distance) for common household cats and on the order of 2 inches (side by side distance) for large dogs. In this regard, it is further contemplated that the length and width dimensions of pet support member 12 may also be tailored to the size of the target pet. For example, for a common household cat, the length might be on the order of 2 feet (as has been generically depicted in FIG. Nos. 1 and 4) and the width might be on the order of 1 foot (as has been generically depicted in FIG. Nos. 4 and 5). As further generically depicted in FIG. No. 2, the length of pet support member 12 may be of greater magnitude to accommodate pets of larger length dimension. FIG. Nos. 2 and 6 depict a first alterative embodiment of the present invention, which is illustrated and referenced as pet bed 11. It should be noted that the primary difference between pet bed 10 and pet bed 11 is the general length of pet support member 12. Further, as shown in FIG. No. 4, the illustrated dimensions depict a substantially rectangular pet support member 12. Pet support member 12 need not be rectangular in configuration, but may take on any number of geometric configurations. It is contemplated that a rectangular configuration is one of the easiest to construct and thus it is this configuration that has been illustrated for purposes of the present disclosure.

In the preferred embodiment, the forced air conduit means 14 essentially provide a dual function, namely, to maintain pet support member 12 in a substantially horizontal state and to provide a guideway for forced air emanating from the source of forced air or forced air source 16 to air-conducting apertures 18 as formed in pet support member 12. In the preferred embodiment, the forced air conduit means 14 thus comprises a superior end 20 as illustrated and referenced in FIG. Nos. 1-7; an inferior end 22 as illustrated and referenced in FIG. Nos. 1-3, and 5-7; and at least one continuous wall 24 joining superior end 20 to inferior end 22 as illustrated and referenced in FIG. Nos. 1-3, and 5-7. Continuous wall 24 is designed so as to maintain pet support member 12 in a first elevated state, preferably on the order of 1 to 2 feet above the floor vent or ground support surface 40 as generally illustrated in FIG. Nos. 1-3, and 5-7. Notably, inferior end 22 is positionable adjacent the source of forced air or forced air source 16 and comprises forced air inlet means 26 as illustrated and referenced in FIG. Nos. 1-3, 5-7, and 9. The source of forced air or forced air outlet (forced air source 16) may preferably be defined by a common household floor vent 28 as illustrated in FIG. Nos. 1-3, and 5-9 or a wall vent 30 as illustrated in FIG. Nos. 5-7. It is noted that the ultimate source of forced air in a household is typically the fan or blower of a furnace or air conditioner. This source feeds forced air (as referenced at 32 in FIG. Nos. 1-3, and 5-7) into a series of air ducts leading to various rooms in a house or similar other building structure. The noted air ducts typically terminate in either floor vents or wall vents depending on the type of construction in a given household or building structure. For purposes of the present invention, the floor vents or wall vents as herein described, define forced air source 16 or forced air outlet of the present invention.

It will be seen from an inspection of FIG. Nos. 3 and 7 that a second alternative embodiment of the present invention concerns a pet bed 13. The primary difference between pet bed 10 and pet bed 13 is that the pet support member 12 of pet bed 13 is in a relatively greater elevated state. Thus the forced air conduit means 14 is essentially of greater height dimension than either pet bed 10 or pet bed 11. It is contemplated that some pets prefer to rest or be sedentary in an elevated position and it is with this notion in mind that the second alternative embodiment of the present invention is disclosed.

Notably, forced air 32 exiting wall vent(s) 30 or floor vent(s) 28 is typically conditioned in some way prior to being forced through the described ductwork. The forced air 32 may either be heated (such as is the case when the home or business owner desires to maintain a heated environment in the vented room) or the air may be cooled or otherwise air conditioned (such as is the case when the home or business owner desires to maintain a cooled or air conditioned environment in the vented room). It is contemplated that the present use of the term “air conditioned” refers to the air that has been treated by a common air conditioning unit. Thus, “air conditioned” is meant to convey the notion that forced air 32 emanating from the source of forced air or forced air source 16 has been either reduced in temperature and/or adjusted for comfortable humidity levels (either by humidifying or dehumidifying the air). The forced air 32, having been treated as described, thus exits air-conducting apertures 18 having traveled through the forced air conduit means 14 and thus maintains the pre-selected ambient temperature and/or humidity level for the pet atop pet support member 12. Forced air 32 has been illustrated exiting air-conducting apertures 18 in FIG. Nos. 1-3, and 5-7 adjacent superior end 20 and pet support member 12.

It will thus be understood that forced air inlet means 26 may be defined by the open bottom of pet beds 10 and/or 11. The forced air inlet means 26 may also be defined by an opening in wall 24 to which vent conduit 34 may be attached as specifically illustrated in FIG. Nos. 5-7. As earlier indicated not all households or building structures comprise floor vent(s) 28. Indeed, many such buildings or shelters comprise wall vent(s) 30. It is thus contemplated that the forced air inlet means 26 be defined by an opening in wall 24 so that vent conduit 34 may direct forced air 32 emanating from wall vent 30 to forced air conduit means 14 for further direction to pet support member 12. It is further contemplated that in buildings or other structures comprising radiators (and boilers) for a heat source, wall vent(s) and/or floor vent(s) 28 will not necessarily be present. In this regard, it is believed that one with ordinary skill in the art may be able to modify the present invention for use in combination with a convective heat source such as a radiator.

It is further contemplated that superior end 20 may be preferably defined by a pet entranceway 36 as illustrated in FIG. Nos. 1-7, inclusive. It will be understood from an inspection of the noted figures that pet entranceway 36 may be defined by at least one continuous superior end wall 38 extending upwardly from pet support member 12 wherein the superior end wall 38 defines a gap for allowing pets more easy access to pet support member 12. In other words, superior end wall 38 bounds or provides a small barrier to pet support member 12 on at least one side as generally depicted in FIG. No. 4 (three sides as shown). It is contemplated that pets often prefer enclosures with at least one entranceway such as here described and illustrated; it is thus contemplated that the inclusion of pet entranceway 36 will increase or enhance the comfort level of the target pet. Further, it is contemplated that the outer or contact surfaces of pet beds 10 and/or 11 may comprise a cushion type covering means to further enhance the comfort level of the target pet. In this regard, it should be noted that should cushion-type covering means be incorporated into the pet bed design, that the covering means should not block air-conducting apertures 18 or otherwise obstruct forced air 32 emanating from air-conducting apertures 18.

### Alternative Embodiment

Given that the first and second alternative embodiments or the present invention (i.e. pet bed 11 and pet bed 13, respectively) comprise only minor differences from pet bed 10 as previously described, the third alternative embodiment is broken out of the detailed description of the preferred embodiment due to various significant structural differences from pet bed 10, as described hereinafter.

The third alternative embodiment of the present invention, or pet bed 15, is generally illustrated and referenced in FIG. Nos. 8 and 9. It will be seen from an inspection of the noted figures that pet bed 15 comprises pet support member 12, forced air conduit means 14, and forced air source 16. It will be further seen, however, that pet support member 12 is in a relatively minimally elevated state and that forced air conduit means 14, while still functioning to direct forced air from the forced air source 16 to pet support member 12, does so by directing forced from either floor vent 28 (as illustrated) or wall vent 30 (not specifically illustrated) in superior adjacency to ground support surface 40. In other words, since pet support member 12 is in a state of minimal elevation above ground support surface 40, forced air will necessarily be directed or conducted close to ground support surface 40. Once forced air passes through forced air inlet means 26 (as referenced in FIG. No. 9), the forced air may be directed via forced air conduit means 14 in inferior adjacency to the length and width of pet support member 12 and then further emanate through air-conducting apertures 18. The first primary difference between pet bed 15 and pet beds 10, 11, and 13 is that forced air conduit means 14 is of minimized height (on the order of 2-3 inches) and thus forced air need not be directed significantly upwards before emanating from air-conducting apertures 18.

It will be further understood that forced air conduit means 14 comprises vent conduit 34 as further illustrated in FIG. Nos. 8 and 9. It is contemplated that vent conduit 34 preferably comprises a forced air inlet end 42, a forced air outlet end 44, and flexible conduit 46 connecting forced air inlet end 42 to forced air outlet end 44. It is contemplated that the user of the present invention may be desirous of positioning the given pet bed at a site remote from either floor vent 28 or wall vent 30. In this regard, flexible conduit 46 enables the user to direct forced air from the given forced air source 16 to the given pet bed (10, 11, 13, or 15) placed or positioned at the remote site. It should thus be noted that flexible conduit 46 may be constructed from flexible conduit of varying lengths depending on the needs of the user.

Further, it should be noted that forced air inlet end 42 and forced air outlet end 44 are uniquely configured. Forced air inlet end 42 is cooperatively associated with either floor vent 28 or wall vent 30 so as to cover a portion thereof. The air flow emanating from forced air source 16 may thus be divided, one portion eventually emanating from air-conducting apertures 18 and another portion emanating from the forced air source 16 directly into the room to be heated or air-conditioned. The forced air inlet end 42 comprises a vent contact perimeter the width of which substantially matches that of the force air source 16 and the length of which is lesser in magnitude that the length of the forced air source 16. Forced air outlet end 44 preferably comprises a width substantially equal in magnitude to the width of pet support member 12 substantially as shown in FIG. No. 9. It is contemplated that forced air outlet end 44 with a width substantially equal in magnitude to the width of pet support member 12 provides the pet bed with more even air flow. Notably, the width of forced air outlet end 44 may also be tailored to substantially match the length of pet support member 12 where forced air inlet means 26 is situated adjacent the length of pet support member 12 (not specifically illustrated) instead of adjacent the width of pet support member 12 substantially as illustrated.

As earlier described, the given pet bed preferably comprises a pet entranceway 36 as further referenced in FIG. Nos. 8 and 9. It will be understood from an inspection of the noted figures that pet entranceway 36 may be defined by at least one continuous superior end wall 38 extending upwardly from pet support member 12 wherein the superior end wall 38 defines a gap for allowing pets more easy access to pet support member 12. As depicted in FIG. Nos. 1-9, the superior end wall 38 lies in three planes, two planes parallel to one another and one plane orthogonally intersecting and connecting the two parallel planes. In other words, superior end wall 38 bounds or provides a barrier to pet support member 12 on at least three sides as generally depicted in FIG. Nos. 8 and 9. It is contemplated that pets often prefer enclosures with at least one entranceway such as here described and illustrated; it is thus contemplated that the inclusion of pet entranceway 36 will increase or enhance the comfort level of the target pet. Further, it is contemplated that the outer surfaces of pet beds 10 and/or 11 may comprise a cushion type covering means to further enhance the comfort level of the target pet. In this regard, it should be noted that should cushion-type covering means be incorporated into the pet bed design, that the covering means should not block air-conducting apertures 18 or otherwise obstruct forced air 32 emanating from air-conducting apertures 18.

The second primary difference between pet bed 15 and pet beds 10, 11, and 13 is that pet bed 15 comprises a bed ceiling 48 as illustrated and referenced in FIG. Nos. 8 and 9. Bed ceiling 48 preferably comprises a substantially planar member and orthogonally intersects the superior end wall 38. As shown, bed ceiling 48 orthogonally intersects the three planes in which superior end wall 38 lies as earlier described. It is contemplated that the distance from pet support member 12 to bed ceiling 48 is on the order of 1-4 feet depending on the size of the target pet. Bed ceiling 48 is preferably constructed from a substantially rigid material, such as wood or plastic. While not designed to be a primary load-bearing structure, bed ceiling 48 may, on occasion, be subjected to loads. In this regard, it is contemplated that pets may alight atop bed ceiling 48 from time to time. It is for this reason that a rigid material is to be preferred in the construction of pet bed 15.

While the above description contains much specificity, this specificity should not be construed as limitations on the scope of the invention, but rather as an exemplification of the invention. For example, as is described hereinabove, it is contemplated that the present invention essentially provides a climatically-controlled bed assembly designed to enhance a pet's or other user's bedded comfort level. The pet bed assembly comprises, in combination, a pet support member, forced air conduit means, and a forced air vent. The pet support member is preferably constructed from a rigid, substantially planar member for supporting at least one pet, such as a cat or dog. The planar member inherently has a superior pet support surface or air-outlet surface, an inferior air-receiving surface or air inlet surface, and a plurality of air-conducting apertures, the air-conducting apertures extending from the superior pet support surface or air outlet surface to the inferior air-receiving or air inlet surface for conducting forced air or an air current from the inferior air-receiving surface to the superior pet support surface. Notably, the air-conducting apertures preferably comprise substantially uniform aperture spacing, the aperture spacing extending intermediate the air-conducting apertures. The aperture spacing is preferably selected from a spacing range, the spacing range ranging from about 1 to 2 inches. It is further contemplated that the air-conducting apertures each preferably comprise a bore axis, the bore axes being substantially orthogonal to the planar member.

The forced air conduit means are designed to maintain the pet support member in a substantially horizontal state and further for providing a forced air or air current conduit. The forced air vent is designed for sourcing or providing a forced air current or other air current (such as a convective air current). The air current thus passes from the forced air vent through the forced air conduit and the air-conducting apertures for climatically-controlling a pet support space or user support space (i.e. that space located in superior adjacency to the superior pet support surface where a pet or user may bed down). The climatically-controlled pet support space is designed for enhancing a pet's comfort level as selectively conditioned air currents are directed into the pet support space. In other words, the air currents may be either heated or cooled or selectively humidified (the humidity level being adjustable) as desired by the user or person charged with care of the pet. In this last regard, it is contemplated that the selectively conditioned forced air or air current may be selected from a conditioned air grouping, the conditioned air grouping consisting of selectively heated forced air, selectively cooled forced air, and a selectively humidified air current.

The forced air conduit means may be defined by preferably comprising a superior conduit end, an inferior conduit end, and at least one continuous conduit wall, the conduit wall joining the superior conduit end to the inferior conduit end. The conduit wall maintains the superior pet support surface in an elevated state. The inferior conduit end comprises forced air inlet means, which are positionable adjacent and cooperatively associated with the forced air source. The superior conduit end may further comprise at least one continuous superior end wall, the superior end wall comprising a pet entranceway. It is contemplated that the pet entranceway may enable pets to gain easy access to the superior pet support surface or climatically-controlled pet support space. Further, it is contemplated that the pet bed assembly may comprise cushion means cooperatively associated with the superior pet support surface and the air-conducting apertures for enhancing the pet's comfort level. In this regard, it is contemplated that the cushion means may comprise a cushion, pillow or similar other padded member having apertures therein, which apertures correspond to the air-conducting apertures so that the air current(s) may pass therethrough and climatically control the pet support space.

Thus, it is contemplated that the present invention discloses a bed assembly for enhancing a pet's bedded comfort level, the bed assembly comprising a support member, air conduit means, and an air current source. The support member is designed to support at least one pet and has a superior pet support surface, an inferior air-receiving surface, and a plurality of air-conducting apertures. The air-conducting apertures extend from the superior pet-support surface to the inferior air-receiving surface for conducting an air current from the inferior air-receiving surface to the superior pet-support surface. The air current source provides the air current, which passes from the air current source to the superior pet support surface via the air conduit means and the air-conducting apertures. The air current climatically-controls the pet support space, which is located in superior adjacency to the superior pet support surface. The climatically-controlled pet support space is designed to enhance a pet's comfort level.

Although the invention has been described by reference to a number of embodiments it is not intended that the novel device be limited thereby, but that modifications thereof are intended to be included as falling within the broad scope and spirit of the foregoing disclosure and the appended drawings.

1. A climatically-controlled pet bed assembly for enhancing a pet's comfort level, the pet bed assembly comprising, in combination, a pet support member, forced air conduit means, and a forced air vent, the pet support member being constructed from a rigid, substantially planar member for supporting at least one pet, the planar member having a superior pet support surface, an inferior air-receiving surface, and a plurality of air-conducting apertures, the air-conducting apertures extending from the superior pet support surface to the inferior air-receiving surface for conducting forced air from the inferior air-receiving surface to the superior pet support surface, the forced air conduit means for maintaining the pet support member in a substantially horizontal state and for providing a forced air conduit, the forced air vent for sourcing a forced air current, the forced air current passing from the forced air vent through the forced air conduit and the air-conducting apertures for climatically-controlling a pet support space, the pet support space being located in superior adjacency to the superior pet support surface, the climatically-controlled pet support space thus for enhancing a pet's comfort level.

2. The pet bed assembly of claim 1 wherein the forced air is selectively conditioned for enhancing the pet's comfort level, the selectively conditioned forced air being selected from a conditioned air grouping, the conditioned air grouping consisting of selectively heated forced air and selectively cooled forced air.

3. The pet bed assembly of claim 2 wherein the selectively conditioned forced air comprises a select humidity level, the select humidity level being adjustable for enhancing the pet's comfort level.

4. The pet bed assembly of claim 1 wherein the forced air conduit means comprises a superior conduit end, an inferior conduit end, and at least one continuous conduit wall, the conduit wall joining the superior conduit end to the inferior conduit end, the conduit wall for maintaining the superior pet support surface in an elevated state, the inferior conduit end comprising forced air inlet means, the forced air inlet means being positionable adjacent and cooperatively associated with the forced air source.

5. The pet bed assembly of claim 4 wherein the superior conduit end comprises at least one continuous superior end wall, the superior end wall comprising a pet entranceway, the pet entranceway for enabling pets to gain easy access to the superior pet support surface.

6. The pet bed assembly of claim 5 comprising cushion means, the cushion means being cooperatively associated with the superior pet support surface and the air-conducting apertures for enhancing the pet's comfort level.

7. The pet bed assembly of claim 1 wherein the air-conducting apertures comprise substantially uniform aperture spacing, the aperture spacing extending intermediate the air-conducting apertures, the aperture spacing being selected from a spacing range, the spacing range ranging from about 1 to 2 inches.

8. The pet bed assembly of claim 7 wherein the air-conducting apertures each comprise a bore axis, the bore axes being substantially orthogonal to the planar member.

9. A climatically-controlled bed assembly for enhancing a user's comfort level, the climatically-controlled bed assembly comprising a support member, air conduit means, and an air current source, the support member for supporting at least one user, the support member having a superior user-support surface, an inferior air-inlet surface, and a plurality of air-conducting apertures, the air-conducting apertures extending from the superior user-support surface to the inferior air-inlet surface for conducting an air current from the inferior air-inlet surface to the superior user-support surface, the air conduit means for providing an air current conduit, the air current source for providing the air current, the air current passing from the air current source through the air conduit means and air-conducting apertures for climatically-controlling a user support space, the user support space being located in superior adjacency to the superior user-support surface, the climatically-controlled user support space for enhancing a user's comfort level.

10. The bed assembly of claim 9 wherein the air current is selectively conditioned for enhancing the user's comfort level, the selectively conditioned air current being selected from a conditioned air grouping, the conditioned air grouping consisting of a selectively heated air current and a selectively cooled air current.

11. The bed assembly of claim 10 wherein the selectively conditioned air current comprises a select humidity level, the select humidity level being adjustable for enhancing the user's comfort level.

12. The bed assembly of claim 9 wherein the air conduit means comprises a superior conduit end, an inferior conduit end, and at least one continuous conduit wall, the conduit wall joining the superior conduit end to the inferior conduit end, the conduit wall for maintaining the superior user-support surface in an elevated state, the inferior conduit end comprising air current inlet means, the air current inlet means being positionable adjacent and cooperatively associated with the air current source.

13. The bed assembly of claim 12 wherein the air current source is selected from a source grouping, the source grouping consisting of a forced air source and a convective air current source.

14. The bed assembly of claim 13 wherein the superior conduit end comprises at least one superior end wall, the superior end wall comprising a user entranceway, the user entranceway for enabling the user to gain easy access to the superior support space.

15. The bed assembly of claim 14 comprising cushion means, the cushion means being cooperatively associated with the superior user-support surface and the air-conducting apertures for enhancing the user's comfort level.

16. The bed assembly of claim 9 wherein the air-conducting apertures comprise substantially uniform aperture spacing, the aperture spacing extending intermediate the air-conducting apertures, the aperture spacing being selected from a spacing range, the spacing range ranging from about 1 to 2 inches.

17. The bed assembly of claim 16 wherein the air-conducting apertures each comprise a bore axis, the bore axes being substantially orthogonal to the support member.

18. A bed assembly for enhancing a pet's comfort level, the bed assembly comprising a support member, air conduit means, and an air current source, the support member for supporting at least one pet, the support member having a superior air outlet surface, an inferior air inlet surface, and a plurality of air-conducting apertures, the air-conducting apertures extending from the superior air outlet surface to the inferior air inlet surface for conducting an air current from the inferior air inlet surface to the superior air outlet surface, the air current source for providing the air current, the air current passing from the air current source to the superior air outlet surface via the air conduit means and the air-conducting apertures, the air current for climatically-controlling a pet support space, the pet support space being located in superior adjacency to the superior air outlet surface, the climatically-controlled pet support space for enhancing a pet's comfort level.

19. The bed assembly of claim 18 wherein the air current is selectively conditioned for enhancing the user's comfort level, the selectively conditioned air current being selected from a conditioned air grouping, the conditioned air grouping consisting of a selectively heated air current, a selectively cooled air current, and a selectively humidified air current.

20. The bed assembly of claim 19 wherein the air current source is selected from a source grouping, the source grouping consisting of a forced air source and a convective air current source.
